(19) United States
(12) Patent Application Publication
(10) Pub. No.: US 2012/0134184 A1
(43) Pub. Date: May 31, 2012

(54) MULTI-LEVEL INVERTER HAVING DUAL CONTROLLER

(75) Inventor: Jong Je PARK, Ansan-si (KR)

(73) Assignee: LSIS CO., LTD.

(21) Appl. No.: 13/303,071

(22) Filed: Nov. 22, 2011

(30) Foreign Application Priority Data
Nov. 30, 2010 (KR) 10-2010-0120439

(51) Int. Cl. H02M 5/458

(52) U.S. Cl. 363/37

(57) ABSTRACT

The present disclosure relates to a multi-level inverter having a plurality of single inverter modules, the multi-level inverter including: a first controller providing a control signal to the multi-level inverter in response to voltage and frequency command based on detection of current and rotation speed of a motor; a second controller providing a control signal to the multi-level inverter in response to voltage and frequency command based on detection of current and rotation speed of a motor; and a plurality of single inverter modules converting an inputted AC power to DC power in response to the control signal from the first controller or the second controller, smoothing the converted DC power, converting the smoothed DC power to a three phase current in response to the control signal and outputting the three phase current.

### MULTI-LEVEL INVERTER HAVING DUAL CONTROLLER

Pursuant to 35 U.S.C.§119 (a), this application claims the benefit of earlier filing date and right of priority to Korean Patent Application No.10-2010-0120439, filed on Nov. 30, 2010, the contents of which is hereby incorporated by reference in their entirety.

### BACKGROUND OF THE DISCLOSURE

1. Field

The teachings in accordance with the exemplary embodiments of this present disclosure generally relate to a multi-level inverter having a dual controller, and more particularly to a multi-level inverter having a dual controller configured to be formed with a first controller and a second controller in a control system, such that when the first controller becomes out of order, the second controller can drive a load.

2. Background

Generally, predetermined driving systems driving a predetermined load are using a driver capable of driving the load. Furthermore, a controller is mounted with the driver to control operation of the driver in order for the systems to accurately drive the load in response to an operation instruction.

In a non-limited example, in case of driving an induction motor as a load, the inverter is generally used as a driver. The inverter switches/converts DC power to AC power, where the converted AC power is supplied to a load.

At this time, a controller is connected to the inverter, and the AC power supplied to the load and frequency can be adjusted to accurately drive the load by allowing the inverter to adjust a switching speed in response to a control signal from the controller. However, the conventional inverter suffers from disadvantages in that there is no way to accurately drive the load, if the control becomes out of order.

### SUMMARY

The present disclosure has been made to solve the foregoing problems of the prior art and therefore an object of certain embodiments of the present disclosure is to provide a multi-level inverter having a dual controller configured to equip a dualized controller for controlling the multi-level inverter, whereby another controller, which is a second controller, can perform a ceaseless operation in a system, when a first controller becomes out of order.

Technical subjects to be solved by the present disclosure are not restricted to the above-mentioned description, and any other technical problems not mentioned so far will be clearly appreciated from the following description by the skilled in the art. That is, the present disclosure will be understood more easily and other objects, characteristics, details and advantages thereof will become more apparent in the course of the following explanatory description, which is given, without intending to imply any limitation of the disclosure, with reference to the attached drawings.

Therefore, an object of the present disclosure is to solve at least one or more of the above problems and/or disadvantages in whole or in part and to provide at least advantages described hereinafter. In order to achieve at least the above objects, in whole or in part, and in accordance with the purposes of the disclosure, as embodied and broadly described, and in one general aspect of the present disclosure, there is provided a multi-level inverter having a plurality of single inverter modules, the multi-level inverter comprising: a first controller providing a control signal to the multi-level inverter in response to voltage and frequency command based on detection of current and rotation speed of a motor; a second controller providing a control signal to the multi-level inverter in response to voltage and frequency command based on detection of current and rotation speed of a motor; and a plurality of single inverter modules converting an inputted AC power to DC power in response to the control signal from the first controller or the second controller, smoothing the converted DC power, converting the smoothed DC power to a three phase current in response to the control signal and outputting the three phase current, wherein the first and second controllers receives a power from any one of mutually independent first power source unit and second power source unit. Preferably, the first and second controllers are connected with the multi-level inverter through a communication line, wherein the communication line is dually configured.

Preferably, each of the single inverter modules includes a rectifier converting the inputted AC power to DC power, and smoothing the converted DC power; an inverter unit converting the smoothed DC power to a three phase current in response to a PWM (Pulse Width Modulation) control signal, and outputting the three phase current; and a PWM controller generating a PWM control signal in response to a control signal outputted from the controller and outputting the PWM control signal to the inverter unit.

Preferably, the PWM controller diagnoses fault of the first controller or the second controller using a control signal outputted from the first controller or the second controller, and stopping operation of a faulted controller and operating another controller if one of the first and second controllers becomes out of order.

Preferably, if any one of the first controller or the second controller is used to control the multi-level inverter, the other controller maintains a wait state.

The multi-level inverter having a dual controller according to the present disclosure has an advantageous effect in that a dualized controller is equipped for controlling the multi-level inverter, whereby another controller, which is a second controller, can perform a ceaseless operation in a system, when a first controller becomes out of order.

### BRIEF DESCRIPTION OF THE DRAWINGS

The accompanying drawings, which are included to provide further understanding of the disclosure and are incorporated in and constitute a part of this application, illustrate embodiment(s) of the disclosure and together with the description serve to explain the principle of the disclosure. In the drawings:

FIG. 1 is a block diagram view illustrating a multi-level inverter system according to an exemplary embodiment of the present disclosure; and

FIG. 2 is an inner circuit diagram of a single inverter module of FIG. 1.

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the example embodiments set forth herein. Rather, these exemplary embodiments are provided so that this description will be thorough and complete, and will fully convey the scope of the present inventive concept to those skilled in the art.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Descriptions of well-known components and processing techniques are omitted so as not to unnecessarily obscure the embodiments of the disclosure.

Hereinafter, a multi-level inverter having a dual controller will be described in detail with reference to the accompanying drawings.

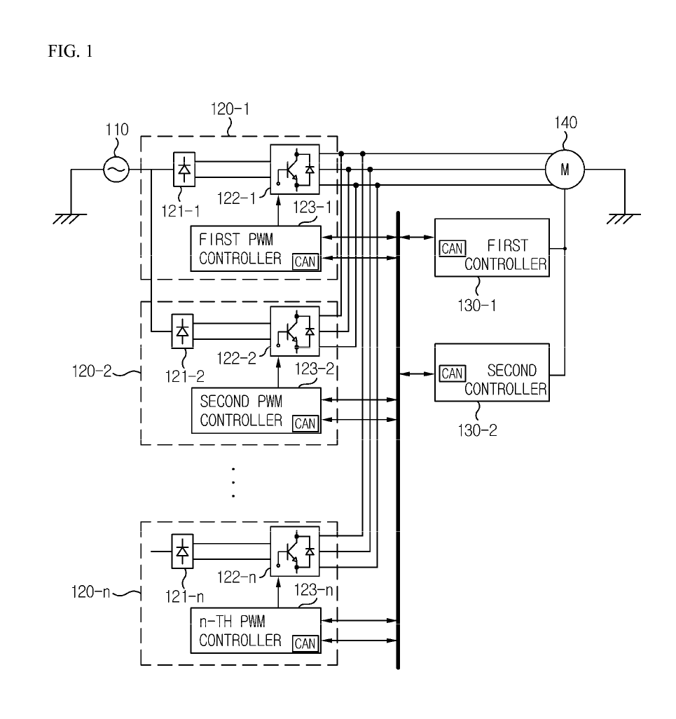

Referring to FIG. 1, which is a block diagram view illustrating a multi-level inverter system according to an exemplary embodiment of the present disclosure, the multi-level inverter system largely includes a first single inverter module (120-1), a second single inverter module (120-2), nth single inverter module (120-n), a first controller (130-1) and a second controller (130-2).

The first single inverter module (120-1) includes a first rectifier (121-1), a first inverter unit (122-1) and a first PWM controller (123-1), and the second single inverter module (120-2) includes a second rectifier (121-2), a second inverter unit (122-2) and a second PWM controller (123-2). Furthermore, the nth single inverter module (120-n) includes a second rectifier (121-n), a second inverter unit (122-n) and a second PWM controller (123-n).

At this time, the first controller (130-1) and the second controller (130-2) have a same circuit and function, and are a configuration for controlling an operation of cascaded H-bridge multi-level inverter having a cascade H-bridge structure.

The first controller (130-1) and the second controller (130-2) may provide a control signal to a single inverter module comprising the multi-level inverter in response to voltage and frequency command based on detection of current and rotation speed of a motor.

The first controller (130-1) and the second controller (130-2) can receive power from at least two power source units, which is to use another non-faulty power source unit when one power source unit becomes faulty. Thus, the first controller (130-1) and the second controller (130-2) can be simultaneously connected to the first power source unit and the second power source unit, and can simultaneously receive power from the first power source unit and the second power source unit (dualization of power).

The multi-level inverter includes a plurality of single inverter modules, where the multi-level inverter may convert an inputted AC power to DC power in response to a control signal from the first controller or the second controller, smoothing the converted DC power, converting the smoothed DC power to a three phase current in response to the control signal and outputting the three phase current. The multi-level inverter may receive an input power (110) of the three phase AC power, converts the input power and provides the power to a motor (140).

The first controller (130-1) or the second controller (130-2) may be connected to the multi-level inverter via a communication line, where the communication line may be configured in a dual structure. That is, the first controller (130-1) or the second controller (130-2) and the multi-level inverter may be connected to a dualized communication line, where if any one of the dualized communication line is out of order, the first controller (130-1) or the second controller (130-2) and the multi-level inverter may be connected to another communication line.

The aforementioned dualization of power source, dualization of communication line and dualization of controller (first controller and second controller) are intended to guarantee a stable control and reliability of the multi-level inverter, which will be described in detail later.

As noted from the foregoing, each of the single inverter modules in the multi-level inverter may include a rectifier (121) converting an inputted AC power to DC power, and smoothing the converted DC power, an inverter unit (122) converting the smoothed DC power to a three phase current in response to a PWM (Pulse Width Modulation) control signal, and outputting the three phase current, and a PWM controller (123) generating a PWM control signal in response to a control signal outputted from the controller and outputting the PWM control signal to the inverter unit.

The rectifiers (121-1, 121-1, . . . 121-n) serves to convert the inputted three phase AC power to DC power, and to smooth/filter the converted DC power when the three phase AC power is applied to the rectifiers (121-1, 121-1, . . . 121-n), where the smoothed DC power is applied to the inverter units (122-1, 122-2, . . . 122-n).

The controllers (130-1, 130-2), the first PWM controller (123-1) and the second PWM controller (123-2) are formed with CAN (Controller Area Network) for use as a communication protocol, and use an optical communication network as communication medium. Although the optical communication network may be WDM (Wave Division Multiplexing) method, the present disclosure is not limited thereto.

The controllers (130-1, 130-2) are connected to the first PWM controller (123-1) to the n-th PWM controller (123-n) to output a signal for control. Each of the PWM controllers (123-1, 123-2, . . . 123-n) uses a CAN driver equipped with data communication and fault diagnosis functions to exchange data signal such as fault diagnosis signal with the controllers (130-1, 130-2).

If it is determined that the control signal from the first or second controller (130-1, 130-2) is faulty or erroneous in each of the PWM controllers (123-1, 123-2, . . . 123-n) of the multi-level inverter, normally operating other controllers (130-1, 130-2) may be operated. The controllers (130-1, 130-2) functions to detect a current and rotation speed using a sensor mounted near the motor, to generate a voltage and a frequency command thereof and to output the voltage and the frequency command to the PWM controllers (123-1, 123-2, . . . 123-n).

The PWM controllers (123-1, 123-2, . . . 123-n) receive the voltage and the frequency command from the controllers (130-1, 130-2) to generate PWM waveforms thereof, and outputs the PWM waveforms to the inverter units (122-1, 122-2, . . . 122-n). The inverter units (122-1, 122-2, . . . 122-n) function to convert the DC power inputted in response to the PWM signal to three phase AC power and output the three phase AC power.

Only one of the first controller (130-1) and the second controller (130-2) may be used for control of the multi-level inverter. In a non-limiting example, if the first controller (130-1) is operated to control the multi-level inverter, the second controller (130-2) may wait maintaining a wait state. If the operating first controller (130-1) becomes out of order, the PWM controllers (123-1, 123-2, . . . 123-n) use the control command to stop operation of the faulty first controller (130-1) and to instead operate the waiting normal (good) second controller (130-2), whereby the motor (140) can be rotated without interruption to enhance reliability with continued operation of the system.

Alternatively, if the operating second controller (130-2) becomes faulty, the PWM controllers (123-1, 123-2, . . . 123-n) use the control command to stop operation of the faulty second controller (130-2) and to instead operate the waiting normal (good) first controller (130-1).

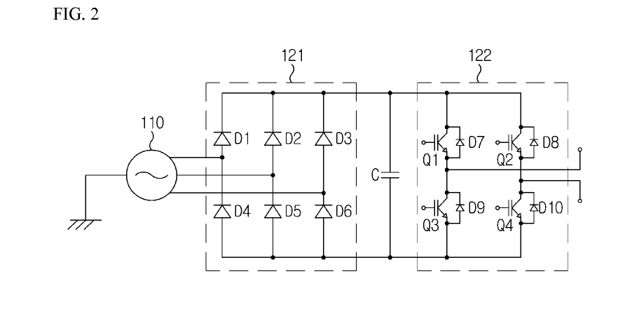

Now, referring to FIG. 2, an inner circuit diagram of the rectifier (121) and the inverter unit (122) of each single inverter module in the multi-level inverter will be described in detail according to an exemplary embodiment of the present disclosure.

The rectifier (121) includes all the rectifiers of the multi-level inverter, i.e., the first rectifier (121-1) to n-th rectifier (121-n), and the inverter unit (122) includes all the inverter units, i.e., the first inverter unit (122-1) to n-th inverter unit (122-n), the configuration of which is representatively illustrated in FIG. 2.

Now, the rectifier (121) and the inverter unit (122) will be explained. The rectifier (121) includes diodes (D1-D6) and capacitor (C). The diodes (D1-D6) performs a three phase full-wave rectification on the inputted AC power (110) to make a ripple voltage, where the ripple voltage becomes a smoothed DC voltage through the capacitor (C).

The DC voltage is inputted as a power source of the inverter unit (122) formed with electronic devices such as MOSFET (Metal-Oxide Semiconductor Field Effect Transistor), IGBT (Insulated-Gate Bipolar Transistor) and GTO (Gate Turn-off Thyristor), where Q1, Q2, Q3 and Q4 are electronic devices to function like a switch, converts the DC voltage to AC voltage and outputs the converted AC voltage. Furthermore, the diodes (D7-D10) function to prevent the electronic devices (Q1, Q2, Q3, Q4) from being damaged by inverse surge voltage from the motor (140).

The previous description of the present disclosure is provided to enable any person skilled in the art to make or use the inventive concept. Various modifications to the disclosure will be readily apparent to those skilled in the art, and the generic principles defined herein may be applied to other variations without departing from the spirit or scope of the disclosure. Thus, the present disclosure is not intended to limit the examples described herein, but is to be accorded the widest scope consistent with the principles and novel features disclosed herein.

The multi-level inverter having a dual controller according to the present invention has an industrial applicability in that a dualized controller is equipped for controlling the multi-level inverter, whereby another controller, which is a second controller, can perform a ceaseless operation in a system, when a first controller becomes out of order.

What is claimed is:

1. A multi-level inverter having a plurality of single inverter modules, the multi-level inverter comprising: a first controller providing a control signal to the multi-level inverter in response to voltage and frequency command based on detection of current and rotation speed of a motor; a second controller providing a control signal to the multi-level inverter in response to voltage and frequency command based on detection of current and rotation speed of a motor; and a plurality of single inverter modules converting an inputted AC power to DC power in response to the control signal from the first controller or the second controller, smoothing the converted DC power, converting the smoothed DC power to a three phase current in response to the control signal and outputting the three phase current, wherein the first and second controllers receives a power from any one of mutually independent first power source unit and second power source unit.

2. The multi-level inverter of claim 1, wherein the first and second controllers are connected with the multi-level inverter through a communication line, wherein the communication line is dually configured.

3. The multi-level inverter of claim 1, wherein each of the single inverter modules includes a rectifier converting the inputted AC power to DC power, and smoothing the converted DC power; an inverter unit converting the smoothed DC power to a three phase current in response to a PWM (Pulse Width Modulation) control signal, and outputting the three phase current; and a PWM controller generating a PWM control signal in response to a control signal outputted from the first controller or the second controller and outputting the PWM control signal to the inverter unit.

4. The multi-level inverter of claim 3, wherein the PWM controller diagnoses a fault of the first controller or the second controller using the control signal outputted from the first controller or the second controller, and stopping operation of a faulted controller and operating another controller if one of the first and second controllers is diagnosed as a fault.

5. The multi-level inverter of claim 1, wherein if any one of the first controller or the second controller is used to control the multi-level inverter, the other controller maintains a wait state.
